(19) United States
(12) Patent Application Publication
(10) Pub. No.: US 2026/0368368 A1
(43) Pub. Date: Nov. 19, 2026

(54) SECURE COMMUNICATION INTERCONNECT FOR INTEGRATED CIRCUIT DEVICES

(71) Applicant: XILINX, INC., San Jose, CA (US)

(72) Inventors: Krishnan SRINIVASAN, San Jose, CA (US); Ygal ARBEL, Morgan Hill, CA (US); Ahmad R. ANSARI, San Jose, CA (US); Sagheer AHMAD, Cupertino, CA (US); James ANDERSON, Madison, AL (US)

(21) Appl. No.: 19/212,325

(22) Filed: May 19, 2025

(51) Int. Cl. G06F 21/72

(52) U.S. Cl. CPC G06F 21/72

(57) ABSTRACT

A multi-chip integrated circuit (IC) device includes a first chiplet and a second chiplet. The first chiplet includes first interconnect circuitry. The first interconnect circuitry encrypts a first signal and output the encrypted signal. The second chiplet includes second interconnect circuitry. The second interconnect circuitry receives the encrypted signal from the first chiplet and decrypt the encrypted signal to generate a decrypted signal. The second interconnect circuitry outputs the decrypted signal to the second chiplet for processing.

### TECHNICAL FIELD

Examples of the present disclosure generally relate to a securing the communication interconnects used to communicate between integrated circuit (IC) devices via cryptography circuitry included within the interconnect circuitry of an IC device.

### BACKGROUND

A multi-chip integrated circuit (IC) device includes multiple chips, or chiplets, that communicate with each other. The chips, or chiplets, are connected to each other via routings within an interposer. As data is communicated between the chips, the data may be accessible by unauthorized users. An unauthorized user may be able to monitor the data traffic communicated between the chips and decipher secure information within the data traffic. The secure information may then be accessible by the unauthorized user and/or the unauthorized user may be able to access previously secure operations or portions of the IC device. Thus, there is a need for an improved system and method for securing the communications between chips in a multi-chip IC device.

### SUMMARY

In one example, a multi-chip integrated circuit (IC) device includes a first chiplet and a second chiplet. The first chiplet includes first interconnect circuitry. The first interconnect circuitry encrypts a first signal and output the encrypted signal. The second chiplet includes second interconnect circuitry. The second interconnect circuitry receives the encrypted signal from the first chiplet and decrypt the encrypted signal to generate a decrypted signal. The second interconnect circuitry outputs the decrypted signal to the second chiplet for processing.

In one example, an IC device includes first interconnect circuitry. The first interconnect circuitry receives a first signal. The first interconnect circuitry encrypts the first signal and outputs the encrypted signal. The first interconnect circuitry is connected to second interconnect circuitry of a second chiplet. The first interconnect circuitry receives a second encrypted signal from the second chiplet and decrypts the second encrypted signal to generate a decrypted signal. The first interconnect circuitry outputs the decrypted signal for processing.

In one example, a method includes encrypting, via first interconnect circuitry of a first chiplet of a multi-chip integrated circuit (IC) device, a first signal and output the encrypted signal. The method further includes receiving, via second interconnect circuitry of a second chiplet of the multi-chip IC device, the encrypted signal from the first chiplet. Further, the method includes decrypting, via the second interconnect circuitry, the encrypted signal to generate a decrypted signal, and outputting the decrypted signal to the second chiplet for processing.

These and other aspects may be understood with reference to the following detailed description.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of a multi-chip integrated circuit (IC) device.

FIG. 2 illustrates a block diagram of a multi-chip IC device.

FIG. 3 illustrates a block diagram of interconnection circuitry of chiplets of a multi-chip IC device.

FIG. 4 illustrates a block diagram of an encryption circuitry block of cryptography circuitry of a chiplet.

FIG. 5 illustrates a block diagram of an encryption circuitry block of cryptography circuitry of a chiplet.

FIG. 6 illustrates a method of generating an encapsulated signal.

FIG. 7 illustrates a block diagram of a decryption circuitry block of cryptography circuitry of a chiplet.

FIG. 8 illustrates a block diagram of a decryption circuitry block of cryptography circuitry of a chiplet.

FIG. 9 illustrates a block diagram of an interconnection circuitry of a chiplet.

FIG. 10 illustrates a block diagram of chiplets of a multi-chip IC device.

FIG. 11 illustrates a block diagram of cryptography circuitry of chiplets of a multi-chip IC device.

FIG. 12 illustrates a flowchart of a method for updating a key of cryptography circuitry of interconnection circuitry of chiplets of a multi-chip IC device.

FIG. 13 illustrates a flowchart of a method for encrypting and decrypting a signal via cryptography circuitry of interconnection circuitry of chiplets of a multi-chip IC device.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

A multi-chip integrated circuit (IC) device includes two or more chiplet ICs (“chiplets), or chips, that are connected to each other. The chiplets may be connected to each other via routings of an interposer. Multi-chip IC devices that are generated from two or more chiplets enable the use of templated architectures to produce large circuits from smaller, duplicated or identical chiplets. The chiplet is part of an overall IC design framework that performs one or more specific functions. In one example, a chiplet may perform acceleration of a machine learning function or other functions of a central processing unit (CPU) or a graphics processing unit (GPU), or another type of processing device.

Data is communicated between the chiplets within a multi-chip IC device to allow for the chiplets to operate together to perform the corresponding functions. However, the chiplets are susceptible to access by an unauthorized user (or malicious actor). For example, an unauthorized user may be able to monitor the data traffic communicated between the chiplets. An unauthorized user may be able to decipher secure information within the data traffic to gain access to the secure information. Further, an unauthorized user may be able to access and/or alter secure operations of the chiplets.

The interface circuitry used to connect the chiplets of a multi-chip IC device can be secured to prevent unauthorized access to communicated data. However, securing the interface circuitry increases the circuit area of the chiplets and increases the power overhead of the chiplets, increasing the cost of manufacturing the corresponding multi-chip IC device.

In the multi-chip IC device described in the following, the interconnect circuitry of the chiplets is used to secure data communicated between the chiplets. Encryption and decryption circuitry is added to the interconnect circuitry to secure the data communicated between the chiplets. As the encryption and decryption occurs within circuitry of the interconnect circuitry of the chiplets, the communicated data can be selectively encrypted and decrypted. Further, using the interconnect circuitry of the chiplets to secure the data communicated between the chiplets, allows for the use of point-to-point communication between the chiplets, creating a tunneled path between the chiplets. Accordingly, critical data can be secured and non-critical data can be communicated without hindering the performance of the corresponding multi-chip IC device. Further, including the encryption an decryption circuitry within the interconnect circuitry uses less circuit area and less power as compared to devices that secure all of the data communicated between the chiplets. Thus, the semiconductor manufacturing costs of the multi-chip IC device as described herein is reduced.

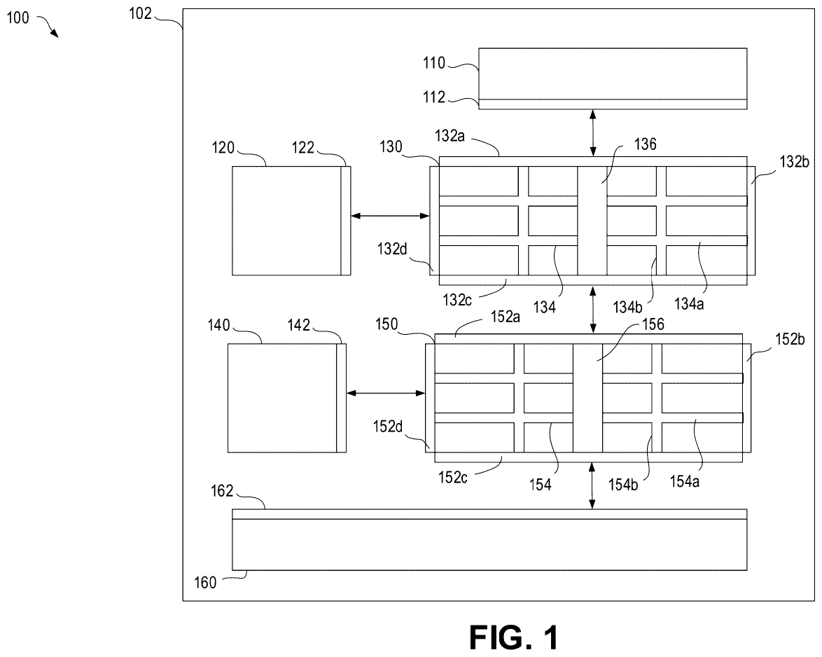

FIG. 1 is a block diagram of a multi-chip IC device 100, according to one or more examples. The multi-chip IC device 100 includes chiplets 110, 120, 130, 140, 150, and 160. In other examples, the multi-chip IC device 100 may include additional chiplets that are configured similar to one or more of 120, 130, 140, and 150.

In one or more examples, the multi-chip IC device 100 is a packaged device. The multi-chip IC device 100 includes a substrate 102. The substrate 102 may be a package substrate, or another type of substrate. In one example, the substrate 102 includes one or more layers. The chiplets 110, 120, 130, 140, 150, and 160 are disposed (e.g., mounted) to the substrate 102. In one or more examples, routings (e.g., traces) within one or more layers of the substrate 102 are used to connect the chiplets 110, 120, 130, 140, 150, and 160 with each other.

Each chiplet 110, 120, 130, 140, 150, and 160 includes circuitry that may comprise a dedicated logic device or device type configured to serve a particular purpose or provide particular functionality. A chiplet may be a processor device configured to perform one or more functions. In one or more examples, a chiplet may be configured as a data processing engine (DPE) chiplet, configured to provide artificial intelligence (AI) or machine learning (ML) functionality. Other chiplets may provide various other functionality, such as Ethernet communications via an Ethernet chiplet, memory functionality via a memory chiplet, and the like. Additionally, or alternatively, a chiplet may include transceiver circuitry and provide transmitter and receiver functionality.

In one or more examples, the chiplets 110-160 may include a homogenous arrangement of chiplets (for example, an arrangement of a single type of chiplet) or a heterogeneous arrangement of chiplets (for example, an arrangement of more than one type of chiplet).

In one example, two or more of the chiplets 110, 120, 130, 140, 150, and 160 may have a similar configuration. Further, two or more of the chiplets 110, 120, 130, 140, 150, and 160 may have a different configuration.

In one or more examples, the chiplet 110 is a memory chiplet, the chiplet 120 is a transceiver chiplet, the chiplet 130 is a processor device chiplet, the chiplet 140 is a transceiver chiplet, the chiplet 150 is a processor device chiplet, and the chiplet 160 is an interface chiplet. The chiplet 110 is connected to the chiplet 130. The chiplet 130 is connected to the chiplet 120 and the chiplet 150. The chiplet 150 is connected to the chiplet 140 and the chiplet 160. The chiplets 110-160 are connected to each other via a physical (or hardwired) and/or similar interface.

In one example, a chip-to-chip (C2C) interface is formed between the chiplet 110 and the chiplet 130, and connects the chiplet 110 with the chiplet 130. The C2C interface may include interface circuitry within the chiplet 110 and/or the chiplet 130. In one example, the C2C interface may be programmable (for example, via a programming software model employing a programming interface for the end user). In some embodiments, the C2C interface comprises digital and analog components that enable communication between components of the chiplet 110 and the chiplet 130.

In one example, the chiplet 110 includes interface circuitry 112 that is included as part of the corresponding C2C interface. The interface circuitry 112 allows for the chiplet 110 to communicate (e.g., output or receive) data with the chiplet 130. The interface circuitry 112 may be referred to as inter-die-bridge circuitry.

The chiplet 130 includes interface circuitry 132 that is included as part of the corresponding C2C interface. The interface circuitry 132 includes interface circuitries 132a, 132b, 132c, and 132d. The interface circuitry 132 may be referred to as inter-die-bridge circuitry. In one example, the interface circuitry 132a is connected to and communicates data with the interface circuitry 112. Further, the interface circuitry 132d is connected to and communicates data with the chiplet 120.

In one example, the chiplet 130 further includes interconnect circuitry 134. The interconnect circuitry 134 may be a network-on-chip (NoC). For example, the interconnect circuitry 134 may be a NoC that includes the horizontal NoC (HNoC) 134a and the vertical NoC (VNoC) 134b. In such an example, the HNoC 134a is interconnected with the VNoC 134b to form the corresponding NoC. The HNoC 134a may be routed in a horizontal direction (or first direction) within the chiplet 130 and the VNoC 134b may be routed in a vertical direction (or second direction) within the chiplet 130. In one or more examples, the interconnect circuitry 134 provides interconnected pathways for data to be communicated within the chiplet 130.

In one example, the interconnect circuitry 134 includes a series of interconnected horizontal (HNoC) and vertical (VNoC) paths. The HNoC and VNoC paths are supported by a customizable and hardware implemented components that can be configured in different ways based on timing, speed, and logic parameters of the corresponding circuit design. In one or more examples, the HNoC and/or VNoC paths are dedicated, high-bandwidth interconnection paths.

The interconnect circuitry 134 provides an on-chip packet-switched communications network. The interconnect circuitry 134 may include one or more packet switches (or NoC packet switches (NPSs)). The interconnect circuitry 134 may present functional circuitry within the chiplet 130 with a virtual interface to another chiplet or element external or internal to the multi-chip IC device 100.

In one or more examples, the interconnect circuitry 134 provides connectivity to the logic circuitry 136 of the chiplet 130. The logic circuitry 136 may include digital processing elements (DPEs), processing system (PS) circuitry, programmable logic (PL), and/or hardware circuit blocks, among others. In one example, the interconnect circuitry 134 is programmable. In such an example, the interconnect circuitry 134 is a programmable NoC. The interconnect circuitry 134 may be programmed by loading configuration data into internal configuration registers that define how elements within the interconnect circuitry 134, such as switches and interfaces are configured and operate to pass data from switch to switch, and among the interconnect circuitry 134.

The interconnect circuitry 134 is fabricated as part of the chiplet 130, and while not physically modifiable, may be programmed to establish connectivity between different circuit elements of the chiplet 130. In one example, the interconnect circuitry 134 includes a plurality of programmable switches that are capable of establishing packet switched network connecting different circuit elements (e.g., master circuits within slave circuits). The interconnect circuitry 134 may be adapted to different circuit designs having different combinations of master circuits and slave circuits implemented at different locations within the interconnect circuitry 134. In one or more examples, the interconnect circuitry 134 is programmed to route data, e.g., application data and/or configuration data, among the master and slave circuits of a corresponding circuit design. In one example, the interconnect circuitry 134 couples elements of the logic circuitry 136 with each other.

In one example, the logic circuitry includes hardware circuit blocks that include input/output (I/O) circuitry and/or transceiver circuitry for sending and receiving signal to circuitry and/or systems external to the chiplet 130. In one or more examples, hardware circuit blocks additionally, or alternatively, include a memory controller and other types of control circuitry. In other examples, I/O circuitry includes single-ended and pseudo differential I/Os and high-speed differentially clock transceivers. In one or more examples, the hardware circuit blocks may be implemented to perform specific functions. Examples of hardware circuit blocks include, but are not limited to, cryptography engines, and digital-to-analog converters, analog-to-digital converters, among others.

In one or more examples, the logic circuitry includes PL circuitry that is implemented as a unified region of programmable circuitry. In one or more examples, the PL circuitry is implemented as more than two different regions of programmable circuitry. In other examples, other configurations of the PL circuitry may be implemented within the chiplet 130.

An example where the interconnect circuitry 134 is a NoC, The interconnect circuitry 134 includes NoC master units (NMUs), NoC slave units (NSUs), switch circuitry (a network), NoC peripheral interconnect (NPI), and register blocks. Each NMU is an ingress circuit (e.g., ingress to the interconnect circuitry 134) that connects a master circuit to the interconnect circuitry 134.

Each NSU is an egress circuit (e.g., egress from the interconnect circuitry 134) that connects the interconnect circuitry 134 to a slave endpoint circuit. An NMU can, in addition to being an ingress circuit, also have egress capabilities. The NMUs are connected to the NSUs through the switch circuitry of the interconnect circuitry 134. In some examples, the switch circuitry includes NoC packet switches (NPSs) and routing between the NPSs. Each NPS performs switching of NoC packets. The NPSs are connected to each other and to the NMUs and NSUs through the routing to implement a plurality of paths. The switching capabilities of each NPS permit one or multiple paths to be implemented through each NPS. The NPSs also support multiple virtual channels per path.

In one example, interconnect circuitry 134 provides stream support. Further, the interconnect circuitry 134 has NMUs and NSUs with a configurable interface width of 32, 64, 128, 256, or 512 bits. In other examples, the configurable interface width may be less than 32 bits or greater than 512 bits. The interconnect circuitry 134 has 64 bit addressing. In other examples, the addressing may be greater than or less 64 bits.

The interconnect circuitry 134 includes circuitry to program the NMUs, NSUs, and NPSs. The interconnect circuitry 134 includes a peripheral interconnect coupled to the register blocks for programming thereof to set functionality of the corresponding NMUs, NSUs, and NPSs. The register blocks in the NoC support interrupts, quality of service (QoS), error handling and reporting, transaction control, power management, and address mapping control. The register blocks for the NMUs and NSUs include registers that can be written to control the operations of the NMUs and NSUs. For example, the register blocks can include registers that enable/disable the NMUs and NSUs, cause the NMUs and NSUs to not transmit and/or to reject any subsequent transaction request to or from the NPSs, and/or instruct the NMUs and NSUs to complete any pending transaction request received from the NPSs. The register blocks of the NPSs can include registers that form a routing table for the corresponding NPS. The register blocks can be initialized in a usable state before being reprogrammed, such as by writing to the register blocks using write requests. Configuration data for the interconnect circuitry 134 can be stored and provided to the NPI for programming the interconnect circuitry 134 and/or other slave endpoint circuits.

In the example, the interconnect circuitry 134 connects endpoint circuits within the chiplet 130. The endpoint circuits are master circuits, which are coupled to NMUs of the interconnect circuitry 134. The endpoint circuits are slave circuits coupled to the NSUs of the interconnect circuitry 134.

The switch circuitry includes a plurality of paths. The paths are implemented by programming the interconnect circuitry 134. Each path includes one or more NPSs and associated routing. An NMU connects with an NSU through at least one path. A path can also have one or more virtual channels.

In one example, one or more NMUs are connected to one or more NSUs. An NMU receives data (e.g., an Advanced eXtensible Interface (AXI) information or other interconnect protocol information) from an endpoint circuit, packetizes the information for transport over the interconnect circuitry 134 via the NPSs via the paths to an NSU. The NSU assembles the packets to re-create the data, and delivers the data to an endpoint circuit.

The chiplet 120 includes interface circuitry 122 that is included as part of the corresponding C2C interface. The interface circuitry 122 may be referred to as inter-die-bridge circuitry. In one example, the interface circuitry 122 is connected to and communicates data with the interface circuitry 132d.

The chiplet 150 includes interface circuitry 152 that is included as part of the corresponding C2C interface. The interface circuitry 152 includes interface circuitries 152a, 152b, 152c, and 152d. The interface circuitry 152 may be referred to as inter-die-bridge circuitry. In one example, the interface circuitry 152a is connected to and communicates data with the interface circuitry 132c. Further, the interface circuitry 132d is connected to and communicates data with the chiplet 160.

In one example, the chiplet 150 further includes interconnect circuitry 154. The interconnect circuitry 154 may be a NoC. For example, the interconnect circuitry 154 may be a NoC that includes the HNoC 154a and the VNoC 154b. The interconnect circuitry 154 is configured similar to that of the interconnect circuitry 134. For example, the interconnect circuitry 154 provides connections between circuit elements of the logic circuitry 156 as is described above with regard to the interconnect circuitry 134 and the logic circuitry 136.

The chiplet 160 includes the interface circuitry 162 that is included as part of the corresponding C2C interface. The interface circuitry 162 allows for the chiplet 160 to communicate (e.g., output or receive) data with the chiplet 150. The interface circuitry 162 may be referred to as inter-die-bridge circuitry.

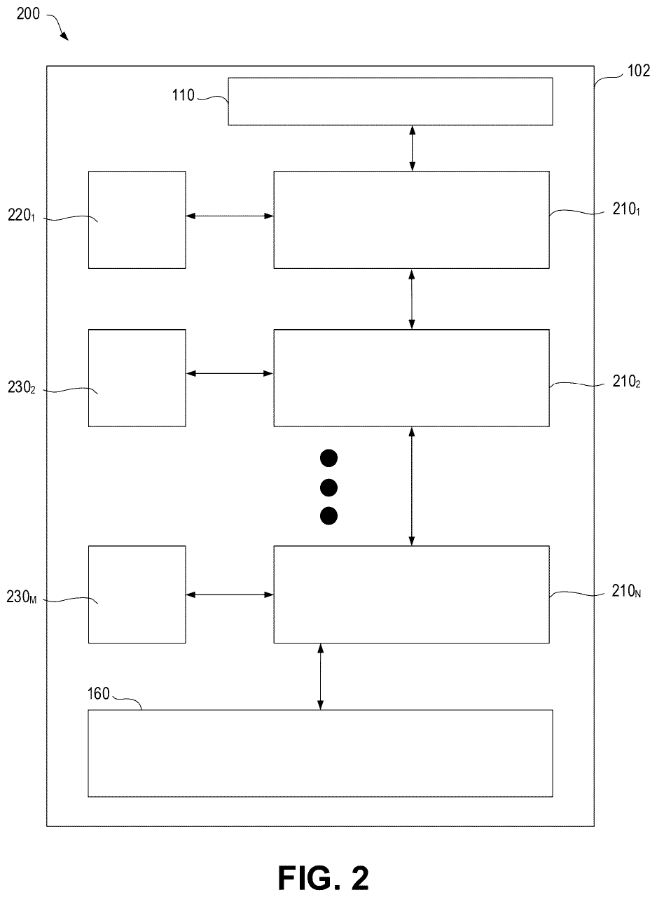

FIG. 2 illustrates the multi-chip IC device 200. The multi-chip IC device 200 includes the chiplets 110, 210, 220, and 160. The chiplets 210 are configured similar to the chiplets 130 and/or 150 of FIG. 1. The multi-chip IC device 200 includes chiplets 210₁-210_{N}. N is two or more. In one example, N is three or more. The chiplets 220 are configured similar to the chiplet 120 and/or the chiplet 140 of FIG. 1. The multi-chip IC device 200 includes chiplets 220₁-220_{M}. M is two or more. In one example, M is three or more. In one or more examples, N is greater than, equal to, or less than M.

In one or more examples, the multi-chip IC device 200 is a packaged device. The multi-chip IC device 200 includes a substrate 102. The chiplets 110, 210, 230, and 160 are disposed (e.g., mounted) to the substrate 102. In one or more examples, routings (e.g., traces) within one or more layers of the substrate 102 are used to connect the chiplets 110, 210, 230, and 160 with each other.

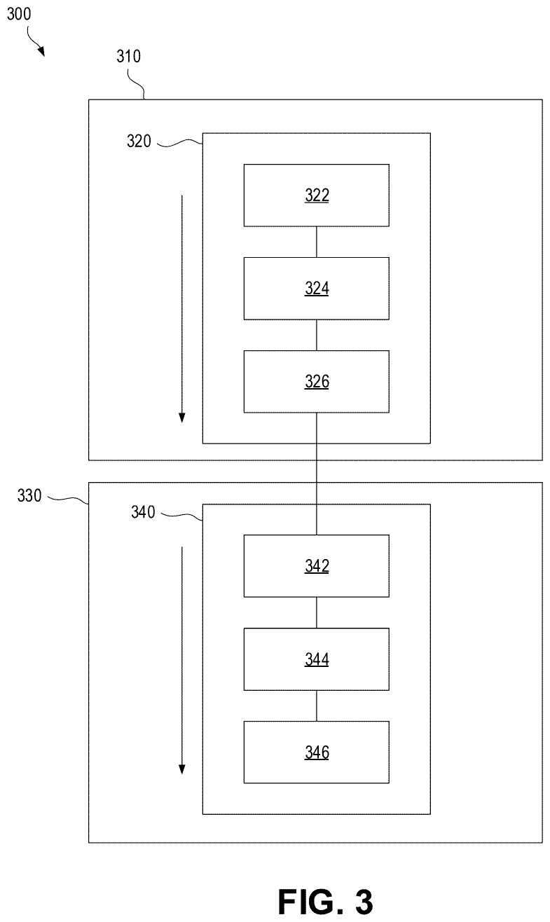

FIG. 3 illustrates at least a portion of the multi-chip IC device 300. The multi-chip IC device 300 includes chiplet 310 and chiplet 330. The chiplet 310 and the chiplet 330 are configured similar to one or more of the chiplets 110, 120, 130, 140, 150, and 160 of FIG. 1. The chiplet 310 includes interconnect circuitry 320. The interconnect circuitry 320 is configured similar to the interconnect circuitry 134 of FIG. 1. Further, the chiplet 330 includes interconnect circuitry 340. The interconnect circuitry 340 is configured similar to the interconnect circuitry 134 of FIG. 1.

The interconnect circuitry 320 is connected to the interconnect circuitry 340, connecting the chiplet 310 with the chiplet 330. The interconnect circuitry 320 includes interface circuitry 322, cryptography circuitry 324, and interface circuitry 326. The interface circuitry 322 may be referred to as inter-chip bridge circuitry. The interface circuitry 326 may be referred to as inter-die bridge circuitry. The cryptography circuitry 324 includes encryption circuitry and decryption circuitry. The cryptography circuitry 324 encrypts (encodes) and decrypts (decodes) data that flows (travels or is communicated through) through the chiplet 310 via the interconnect circuitry 320. In one example, the cryptography circuitry 324 selectively encrypts and/or decrypts data based on an identifier of the data. Accordingly, in one or more examples, not all of the data flowing through the interconnect circuitry 320 is encrypted and/or decrypted. For example, data may be selectively encrypted and decrypted.

The cryptography circuitry 324 is disposed between the interface circuitry 322 and the interface circuitry 326. In other examples, the cryptography circuitry 324 may be disposed at other locations within the interconnect circuitry 320.

The interconnect circuitry 340 is connected to the interconnect circuitry 320, connecting the chiplet 330 with the chiplet 310. The interconnect circuitry 340 includes interface circuitry 342, cryptography circuitry 344, and interface circuitry 346. The interface circuitry 342 may be referred to as inter-chip bridge circuitry. The interface circuitry 346 may be referred to as inter-die bridge circuitry. The cryptography circuitry 344 includes encryption circuitry and decryption circuitry. The cryptography circuitry 344 encrypts and decrypts data that flows (travels or is communicated through) through the chiplet 330 via the interconnect circuitry 340. In one example, the cryptography circuitry 344 selectively encrypts and/or decrypts data based on an identifier of the data. Accordingly, in one or more examples, not all of the data flowing through the interconnect circuitry 340 is encrypted and/or decrypted. For example, data may be selectively encrypted and decrypted.

The cryptography circuitry 344 is disposed between the interface circuitry 342 and the interface circuitry 346. In other examples, the cryptography circuitry 344 may be disposed at other locations within the interconnect circuitry 340.

In one example, the cryptography circuitry 324 receives data, determines that the data is to be encrypted and encrypts the data. The encrypted data is communicated from the interconnect circuitry 320 to the interconnect circuitry 340. The cryptography circuitry 344 receives the encrypted data and determines that the encrypted data is to be decrypted. The cryptography circuitry 344 decrypts the encrypted data, and outputs the decrypted data. In one or more examples, the cryptography circuitry 344 receives data, determines that the data is to be encrypted and encrypts the data. The encrypted data is communicated from the interconnect circuitry 340 to the interconnect circuitry 320. The cryptography circuitry 324 receives the encrypted data and determines that the encrypted data is to be decrypted. The cryptography circuitry 324 decrypts the encrypted data, and outputs the decrypted data.

In one or more examples, the cryptography circuitry 324 and the cryptography circuitry 344 use a Galois/Counter Mode (GCM) encryption/decryption process to communicate encrypted data between the corresponding interconnect circuitries 320 and 340. A GCM encryption/decryption process may be referred to as an authenticated encryption, and provides data authenticity (integrity) and confidentiality when communicating data between the corresponding interconnect circuitries 320 and 340. In one example in a GCM encryption/decryption process, header information includes authentication of the corresponding data. A GCM encryption/decryption processes corresponds to a mode of operation for symmetric-key cryptographic block ciphers. In a GCM encryption/decryption process, authenticated encryption with associated data methods is used for data authenticity (integrity) and confidentiality. Further, in a GCM encryption/decryption process, data (e.g., plaintext) is encrypted with a key to produce a ciphertext. An authentication tag is generated from the ciphertext and the associated data. The encrypted data (e.g., ciphertext) is decrypted with the key, and the decrypted data is authenticated with the authentication tag. In other examples, other types of encryption/decryption processes may be used.

In one or more examples, encrypted data to be transmitted by the cryptography circuitry 324 is secured with a hash function (or algorithm) for authentication. For example, data is authenticated with a secure hash function, and once the data is determined to be secure, the data is encrypted and transmitted to the cryptography circuitry 344. The hash function (algorithm) may be a MD based hash function, or a security hashing algorithm (SHA), among others. In one example, to perform a hash function, data is mapped using a hash function to a fixed size (e.g., a hash value, a hash code, or a hash sum). The fixed size may be 256 bits. In other examples, the fixed size may be greater than or less than 256 bits.

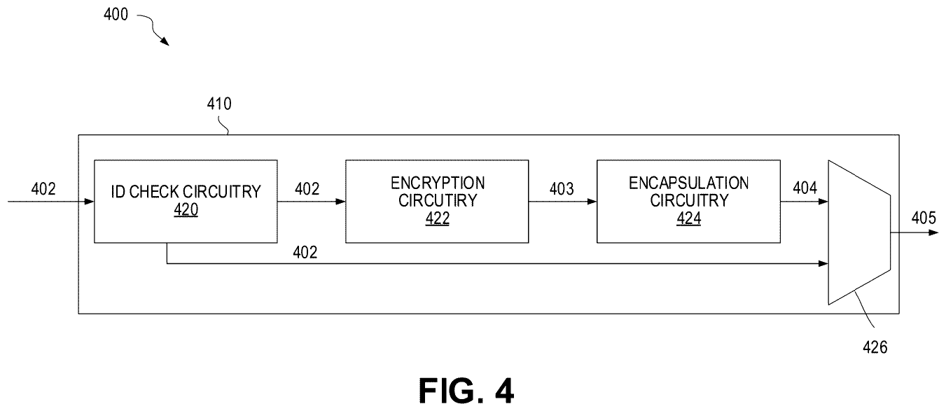

FIG. 4 illustrates at least a portion of the cryptography circuitry 400. The cryptography circuitry 400 includes encryption circuitry block 410. In one example, a tunnel is formed between the encryption circuitry block 410 in one chiplet and the decryption circuitry block in another chiplet.

The encryption circuitry block 410 includes identifier (ID) check circuitry 420, encryption circuitry 422, encapsulation circuitry 424, and selection circuitry 426. The ID check circuitry 420 includes an input that receives the signal 402 and an output connected to an input of the encryption circuitry 422. The output of the encryption circuitry 422 is connected to an input of the encapsulation circuitry 424. An output of the encapsulation circuitry 424 is connected to a first input of the selection circuitry 426. Further, an output of the ID check circuitry 420 is connected to a second input of the selection circuitry 426. The selection circuitry 426 selects one of the inputs and outputs the signal 405. In one example, the selection circuitry 426 selects and outputs the output of the encapsulation circuitry 424 as the signal 405. Accordingly, in such an example, the signal 405 is an encrypted signal. In another example, the selection circuitry 426 selects and outputs the signal 402 output by the ID check circuitry 420 as the signal 405. In such an example, the signal 405 is not encrypted.

In one example, the ID check circuitry 420 receives the signal 402. The ID check circuitry 420 determines whether or not the signal 402 is to be encrypted based on the ID of the signal 402. For example, the ID check circuitry 420 may compare the ID of the signal 402 to a list of IDs to determine whether or not to encrypt the signal 402. The list of IDs may correspond to the data that is to be encrypted. In one example, the signals to be encrypted share a common encryption ID. The ID check circuitry 420 determines whether or not the ID of the signal corresponds to the encryption ID. For example, the ID check circuitry 420 determines that the ID of the signal 402 is the encryption ID by comparing the ID of the signal 402 to the encryption ID, and outputs the signal 402 to the encryption circuitry 422. Based on the ID check circuitry 420 determining that the ID of the signal 402 does not match the encryption ID, the signal 402 is output to the selection circuitry 426, and is not encrypted.

In one example, the data of the signal 402 is authenticated using a hash function before the data of the signal 402 is encrypted by the encryption circuitry 422. In one example, the data of the signal 402 is authenticated after the signal 402 is determined to match an encryption ID and is to be encrypted.

The encryption circuitry 422 receives the signal 402 to be encrypted from the ID check circuitry 420, and encrypts the signal 402 generating the encrypted signal 403. The encryption circuitry 422 uses an advanced encryption standard (AES) encryption algorithm to encrypt the signal 402. The encryption circuitry 422 may use a 128, 192, or a 256, or more, bit key for encryption. In other examples, the encryption circuitry 422 may use a Rivest-Shamir-Adleman (RSA) encryption algorithm to encrypt the signal 402. In yet other examples, other types of encryption algorithms may be used.

The encryption circuitry 422 outputs the encrypted signal 403 to the encapsulation circuitry 424. The encapsulation circuitry 424 receives the encrypted signal 403 and generates the encapsulated signal 404. For example, the encapsulation circuitry 424 encapsulates the signal into a communication protocol associated with the corresponding interconnect circuitry (e.g., the interconnect circuitry 320 of FIG. 3) to generate the encapsulated signal 404. In one example, the communication protocol is an AXI stream protocol. The encapsulated signal 404 is output to the selection circuitry 426.

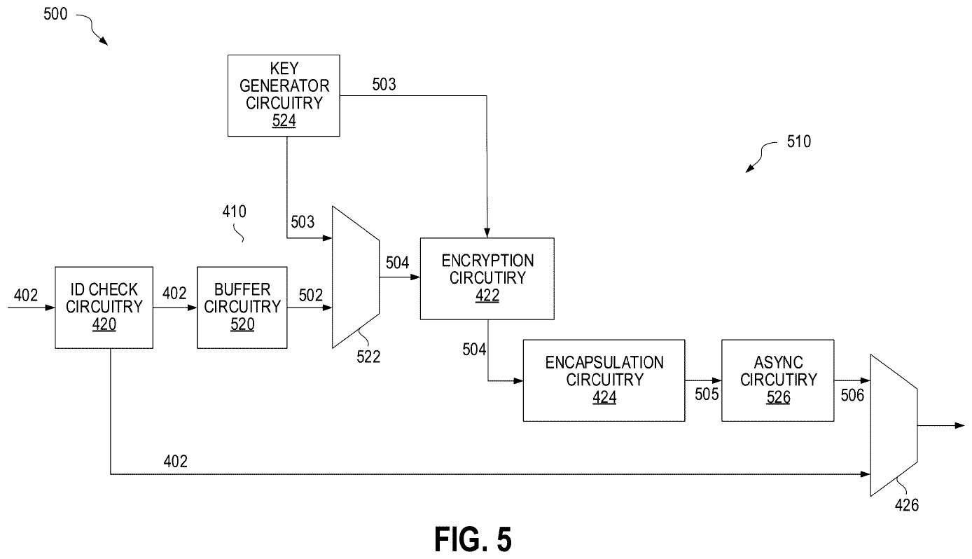

FIG. 5 illustrates at least a portion of the cryptography circuitry 500. The cryptography circuitry 500 includes encryption circuitry block 510. In one example, a tunnel is formed between the encryption circuitry block 510 in one chiplet and the decryption circuitry block in another chiplet.

The encryption circuitry block 510 includes the ID check circuitry 420, buffer circuitry 520, selection circuitry 522, key generator circuitry 524, the encryption circuitry 422, the encapsulation circuitry 424, Asynchronous (Async) circuitry 526, and the selection circuitry 426. The ID check circuitry 420 includes an input that receives the signal 402 and an output connected to an input of the buffer circuitry 520. The output of the buffer circuitry 520 is connected to a first input of the selection circuitry 522. An output of the key generator circuitry 524 is connected to a second input of the selection circuitry 522. The output of the selection circuitry 522 is connected to an input of the encryption circuitry 422. An output of the key generator circuitry 524 is connected to an input of the encryption circuitry 422. The output of the encryption circuitry 422 is connected to an input of the encapsulation circuitry 424. An output of the encapsulation circuitry 424 is connected to an input of the async circuitry 526. An output of the async circuitry 526 is connected to a first input of the selection circuitry 426. Further, an output of the ID check circuitry 420 is connected to a second input of the selection circuitry 426. The selection circuitry 426 selects one of the inputs and outputs the signal 405. In one example, the selection circuitry 426 selects and outputs the output of the async circuitry 526 as the signal 507. Accordingly, in such an example, the signal 507 is an encrypted signal. In another example, the selection circuitry 426 selects and outputs the signal 402 output by the ID check circuitry 420 as the signal 405. In such an example, the signal 405 is not encrypted.

In one example, the ID check circuitry 420 receives the signal 402. The ID check circuitry 420 determines whether or not the signal 402 is to be encrypted based on the ID of the signal 402 as is described above.

The buffer circuitry 520 receives the signal 402 and buffers the signal 402. In one example, the buffer circuitry 520 is an asynchronous buffer. Additionally, or alternatively, the buffer circuitry 520 is a first-in-first-out (FIFO) buffer. In one example, the ID check circuitry 420 is a in a first clock domain, and the buffer circuitry 520 converts the signal 402 from the first clock domain to a second clock domain. In such an example, the key generator circuitry 524, the selection circuitry 522, the encryption circuitry 422, and the encapsulation circuitry operate in the second clock domain, which is different (e.g., has a different frequency and/or phase) than the first clock domain. The buffer circuitry 520 outputs the signal 502 in the second clock domain.

The selection circuitry 522 is a multiplexer or another type of selection circuitry. The selection circuitry 522 receives, at a first input, the signal 502. At a second input, the selection circuitry 522 receives the signal 503. The signal 502 may include an updated encryption key. In one example, the selection circuitry 522 selects and outputs the signal 502 as the signal 504. In another example, when the encryption key has been changed, the selection circuitry 522 outputs the encryption key as the signal 503 as the signal 504.

The encryption circuitry 422 receives the signal 504 to be encrypted from the selection circuitry 522 and the encryption key via the signal 503 from the key generator circuitry 524. The encryption circuitry 422 encrypts the signal 402 generating the encrypted signal 504 using the encryption key via the signal 503. As is described above, the encryption circuitry 422 uses an encryption algorithm to encrypt the signal 504. The encryption circuitry 422 outputs the encrypted signal 504 to the encapsulation circuitry 424.

The encapsulation circuitry 424 receives the encrypted signal 504 and generates the encapsulated signal 505. For example, the encapsulation circuitry 424 encapsulates the signal 504 into a communication protocol associated with the corresponding interconnect circuitry (e.g., the interconnect circuitry 320 of FIG. 3) to generate the encapsulated signal 505. In one example, the communication protocol is an AXI stream protocol. The encapsulated signal 505 is output to the async circuitry 526

The async circuitry 526 receives the encapsulated signal 505, and converts the encapsulated signal 505 from the second clock domain to the first clock domain, generating the signal 506. The signal 506 is output the selection circuitry 426. The selection circuitry 426 selects and outputs one of the signal 506 and the signal 502 as the signal 507.

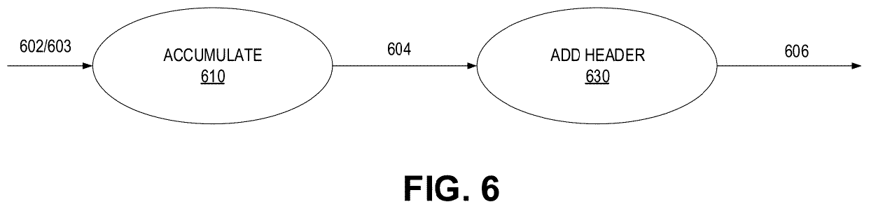

FIG. 6 illustrates the encapsulation operations performed by the encapsulation circuitry 424 to encapsulate an encrypted signal to generate an encapsulated signal. The encapsulation circuitry 424 generates the encapsulated signal having a programmable length. In one example, for each transaction (e.g., each AXI transaction) a header is added. In one example of FIG. 6, the signal to be encrypted is a memory write transaction signal (e.g., a write transaction). At operation 610 for a write transaction, an accumulate process is performed by the encapsulation circuitry 424 to accumulate the entire write transaction including the request. In one example, buffer circuitry is used to perform the accumulation. For example, buffer circuitry (or buffer circuitries) is included within the encapsulation circuitry 424 of FIG. 4. The buffer circuitry may be a FIFO buffer circuitry. In other examples, other types of buffer circuitries may be used.

At the operation 610, the encapsulation circuitry 624 receives the signal 602 associated with a write transaction, and accumulates the signal 602 until the entire write transaction has been received. The write transaction may be transmitted using a burst mode. For example, the write transaction may consist of multiple beats (or data transfers). A beat refers to a single data transfer that occurs during a burst of data. A beat is a single cycle where a portion of the data of the write transaction is communicated. The encapsulation circuitry 424 accumulates the first beat (signal 602) and intermediate beats (e.g., signal 603) until the last beat is received, and the write transaction is completed. In one example, an indicator is added and transmitted with the last beat to identify the last beat as being the last beat of the write transaction.

Based on the determination that the last beat of the write transaction has been received (e.g., the write transaction is completed), the accumulated beats of the write transaction are output and a header is added at operation 620. For example, the encapsulation circuitry 424 adds a header to the signal 604 containing the accumulated beats. The header consists of the authentication information, size of the transaction in beats, and identifier of the key that was used for encryption.

The encapsulation circuitry 424 outputs the signal 606 that includes the accumulated beats of the transaction and the header.

In another example of FIG. 6, the signal to be encrypted is a memory read transaction signal (e.g., a read transaction) or includes beats (or responses) of a memory read transaction. At operation 610 for read transactions, an accumulate process is performed by the encapsulation circuitry 424 to accumulate read beats (read responses) of memory read transactions. The read beats may correspond to one or more read transactions. In one example, the buffer circuitry of the encapsulation circuitry 424 is used to perform the accumulation. As compared to write transaction, read beats of different read transactions can be interleaved with each other. Accordingly, counter circuitry within the encapsulation circuitry 424 is used to count the number of received read beats. The number of read beats is compared to a first threshold, and based on the number of read transactions meeting and/or exceeding the first threshold, the read transactions are output and encrypted. The first threshold may also be referred to a maximum or upper threshold. In one example, the operation 610 is performed to accumulate beats of a read transaction or transactions. The count of the counter circuitry is increased each time a beat of a read transaction is received and/or accumulated. Based on the count (e.g., number of received and accumulated beats) meeting or exceeding the first threshold, the accumulated beats are output as the signal 604, and the header is added at operation 620 as is described above. In one example, the accumulated beats are further output as the signal 504 based on a bubble cycle not being received. A bubble cycle corresponds to a cycle (e.g., beat) where not data is transmitted or received.

The encrypted signal 606 is output including the encrypted accumulated beats and the added header.

In one or more examples, as the read beats (e.g., read transactions) are interleaved, the accumulate read beats may be from one or more tread transactions. The accumulated read beats are encapsulated by the encapsulation circuitry 424 into a single signal (or stream) 606 of encrypted read beats.

In one example, the accumulated read beats at 610 are output as the signal 604 based on the count of received and accumulated beats being greater than a second (e.g., a lower or minimum) threshold and the receipt of a bubble cycle (or beat). The second threshold has a value that is less than the first threshold.

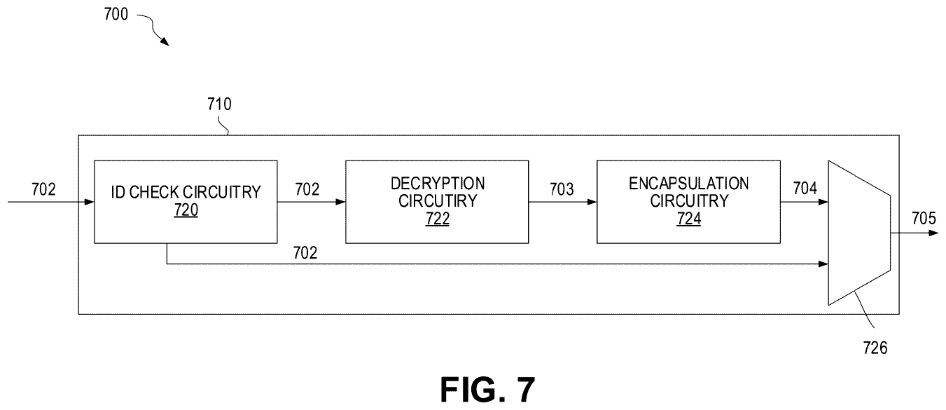

FIG. 7 illustrates at least a portion of cryptography circuitry 700. The cryptography circuitry 700 includes decryption circuitry block 710. In one example, a tunnel is formed between the decryption circuitry block 710 in one chiplet and the encryption circuitry block in another chiplet.

The encrypted signal 702 is received by the decryption circuitry block 710. The decryption circuitry block 710 receives the signal 702. In one example, the signal 702 is an encrypted signal and includes the encrypted data and the header. The decryption circuitry block 710 determines the header information. Further, the decryption circuitry block 710 determines that the encrypted data is to be decrypted (e.g., an encrypted signal) based on an ID check as is described above with regard to the encryption circuitry block 410 of FIG. 1. For example, based on an ID of the encrypted signal 702 matching a decryption identifier, the encrypted data of the signal 702 is decrypted. The decryption process corresponds to the encryption process. In one example, the key within the header is used to decrypt the encrypted data of the signal 702 to generate the decrypted signal 703. In one or more examples, the encryption key is provided to the decryption circuitry 722 from another source, and is used to generate the decrypted signal 703 from the signal 702. In one example, decrypting the encrypted data of the signal 702 includes decrypting the beats. The decrypted beats for a write transaction are output based on the corresponding communication protocol of the interconnect circuitry (e.g., the interconnect circuitry 134 of FIG. 1). In one example for a write transaction, the header is discarded and the decrypted beats are output by the interconnect circuitry. As with a write transaction, the decrypted beats for a read transaction are output based on the corresponding communication protocol of the interconnect circuitry (e.g., the interconnect circuitry 134 of FIG. 1). Further, for a read transaction, the header is discarded and the decrypted beats are output (e.g., forwarded one by one) by the interconnect circuitry.

The encapsulation circuitry 724 receives the decrypted signal 703, and generates the encapsulated signal 704. The encapsulated signal 704 is generated as described above with regard to generating the encapsulated signal 404 of FIG. 4.

The selection circuitry 726 is a multiplexer circuitry. In another example, the selection circuitry 726 is another type of selection circuitry. The selection circuitry 726 receives the encapsulated signal 704 and the signal 702, and selects and outputs one of the encapsulated signal 704 and the signal 702 as the signal 705.

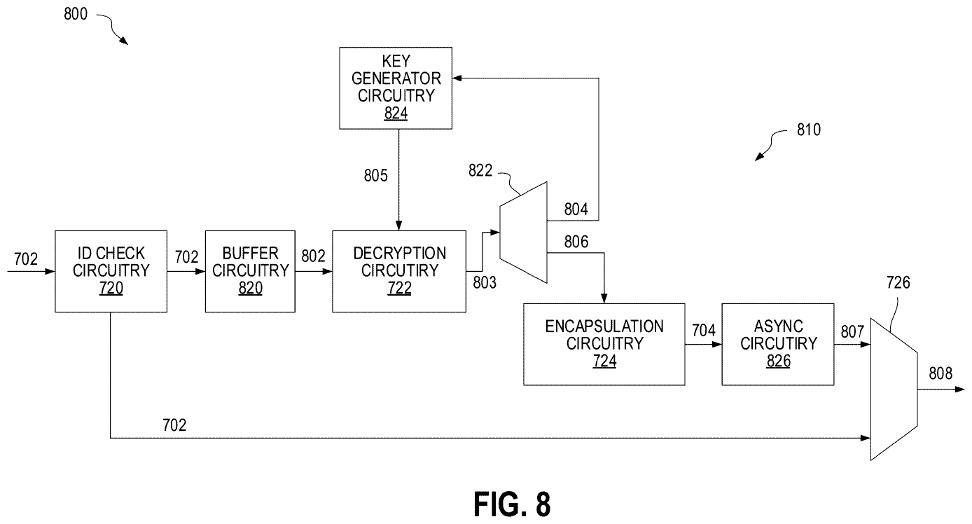

FIG. 8 illustrates at least a portion of the cryptography circuitry 800. The cryptography circuitry 800 includes decryption circuitry block 810.

The decryption circuitry block 810 includes the ID check circuitry 720, buffer circuitry 820, demultiplexer circuitry 822, key generator circuitry 824, the decryption circuitry 722, the encapsulation circuitry 724, async circuitry 826, and the selection circuitry 726. The ID check circuitry 720 includes an input that receives the signal 702 and an output connected to an input of the buffer circuitry 820. The output of the buffer circuitry 820 is connected to the decryption circuitry 722. An output of the decryption circuitry 722 is connected to an input of the demultiplexer circuitry 822. An output of the key generator circuitry 824 is connected to a second input of the decryption circuitry 722. A first output of the demultiplexer circuitry 822 is connected to an input of the key generator circuitry 824 and a second output of the demultiplexer circuitry 822 is connected to an input of the encapsulation circuitry 724. An output of the encapsulation circuitry 724 is connected to an input of the async circuitry 826. An output of the async circuitry 826 is connected to a first input of the selection circuitry 726. Further, an output of the ID check circuitry 720 is connected to a second input of the selection circuitry 426. The selection circuitry 426 selects one of the inputs and outputs the signal 808. In one example, the selection circuitry 726 selects and outputs the output of the async circuitry 826 as the signal 808. In another example, the selection circuitry 726 selects and outputs the signal 702 output by the ID check circuitry 720 as the signal 808. In such an example, the signal 808 is not encrypted and decrypted.

In one example, the ID check circuitry 720 receives the signal 702. The ID check circuitry 720 determines whether or not the signal 702 is to be decrypted based on the ID of the signal 702 as is described above.

The buffer circuitry 820 receives the signal 702 and buffers the signal 702. In one example, the buffer circuitry 820 is an asynchronous buffer. Additionally, or alternatively, the buffer circuitry 820 is a FIFO buffer. In one example, the ID check circuitry 720 is a in a first clock domain, and the buffer circuitry 820 converts the signal 702 from the first clock domain to a second clock domain. In such an example, the key generator circuitry 824, the demultiplexer circuitry 822, the decryption circuitry 722, and the encapsulation circuitry 724 operate in the second clock domain, which is different (e.g., has a different frequency and/or phase) than the first clock domain. The buffer circuitry 820 outputs the signal 802 in the second clock domain.

The decryption circuitry 722 receives the signal 802 to be decrypted and the encryption key via the signal 804 from the key generator circuitry 824. The decryption circuitry 722 decrypts the signal 802, generating the decrypted signal 803 using the key 805. As is described above, the decryption circuitry 722 uses a decryption algorithm to decrypt the signal 802. The decryption circuitry 722 outputs the decrypted signal 803 to the demultiplexer circuitry 822.

The demultiplexer circuitry 822 receives the signal 803. The demultiplexer circuitry 822 outputs the signals 804 and 806 to the key generator circuitry 824 and the encapsulation circuitry 724, respectively. In one example, the demultiplexer circuitry 822 outputs the signal 803 as the signal 806. In another example, when the encryption key has been changed, the demultiplexer circuitry 822 outputs the signal 803 as the signal 804.

The encapsulation circuitry 724 receives the signal 806 and generates the encapsulated signal 704. For example, the encapsulation circuitry 724 encapsulates the signal 806 into a communication protocol associated with the corresponding interconnect circuitry (e.g., the interconnect circuitry 320 of FIG. 3) to generate the encapsulated signal 704. In one example, the communication protocol is an AXI stream protocol. The encapsulated signal 704 is output to the async circuitry 826.

The async circuitry 826 receives the encapsulated signal 704, and converts the encapsulated signal 705 from the second clock domain to the first clock domain, generating the signal 806. The signal 806 is output to the selection circuitry 726. The selection circuitry 726 selects and outputs one of the signal 807 and the signal 702 as the signal 808.

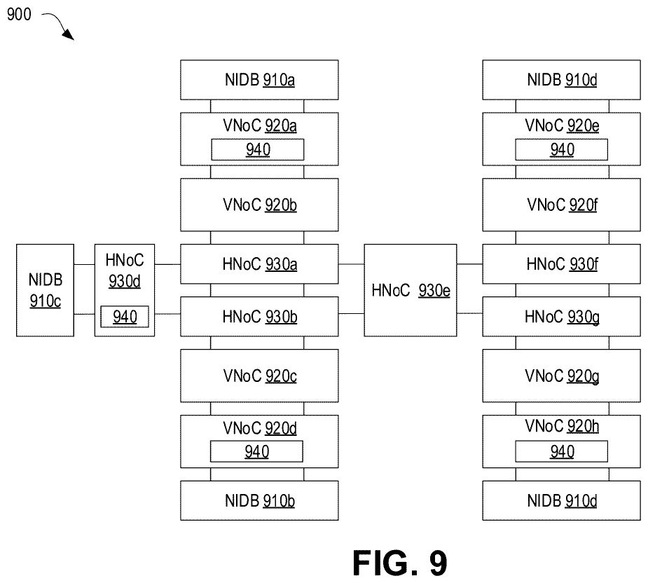

FIG. 9 illustrates a portion of interconnect circuitry 900. The interconnect circuitry 900 is configured similar to the interconnect circuitry 134 of FIG. 1. In one example, the interconnect circuitry 900 is NoC circuitry. In such an example, the interconnection circuitry 900 includes NoC inter-die-bridge (NIDB) circuitry 910, VNoC circuitry 920, and HNoC circuitry 930. The NIDB circuitry 910 includes interface circuitry configured similar to the interface circuitry 132 of FIG. 1. Each of the VNoC circuitries 920 includes NPSs, NMUs, and/or NSUs to route data signals through interconnect circuitry. Further, each of the HNoC circuitries 930 includes NPSs, NMUs, and/or NSUs to route data signals through interconnect circuitry. In one example, the cryptography circuitry 940 is included within one or more of the VNoC circuitries 920 and/or the HNoC circuitries 930. The cryptography circuitry 940 is configured similar to the cryptography circuitry 324. In one example, as is illustrated in FIG. 9, the cryptography circuitries 940 are included within the VNoC circuitries 920 that are closest to the corresponding NIDB circuitry 910. For example, as is illustrated in FIG. 9, the cryptography circuitry 940 is included within the VNoC circuitry 920a instead of the VNoC circuitry 920b as the VNoC circuitry 920a is closer to the NIDB circuitry 910a than the VNoC circuitry 920b. Further, as is illustrated in FIG. 9, the cryptography circuitries 940 are included within the HNoC circuitries 940 that are closest to the corresponding NIDB circuitry 910. For example, as is illustrated in FIG. 9, the cryptography circuitry 940 is included within the HNoC circuitry 920d instead of the HNoC circuitry 930a or the HNoC circuitry 930b as the HNoC circuitry 930d is closer to the NIDB circuitry 910c than the HNoC circuitry 930a or the HNoC circuitry 930b. In other examples, one or more of the cryptography circuitries 940 may be included in other locations (e.g., within other ones of the VNoC circuitries 920 and/or HNoC circuitries 930). Further, more or less cryptography circuitries 940 may be included within the interconnect circuitry 900 than that illustrated in FIG. 9.

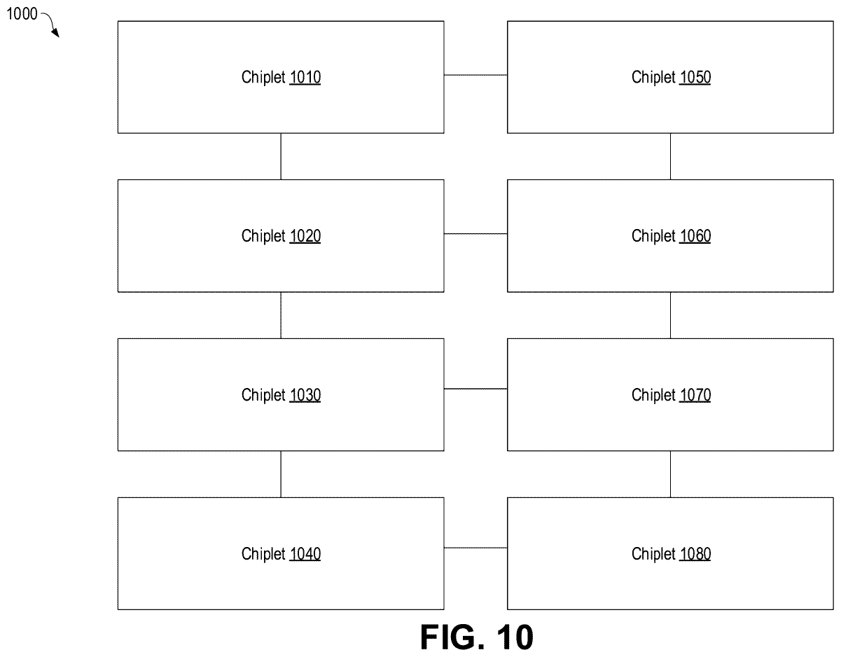

FIG. 10 illustrates the multi-chip IC device 1000. The multi-chip IC device 1000 includes chiplets 1010-1080. The chiplets 1010-1080 are configured similar to one or more of the chiplets 110-160 of FIG. 1. In one example, the chiplet 1010 is configured to encrypt a data signal and output the data signal. The chiplet 1080 is the target for the encrypted data signal. The encrypted data signal travels through various combinations of the chiplets 1020-1070 before reaching the chiplet 1080. For example, the encrypted data signal may travel from the chiplet 1010 to the chiplet 1080 by passing through the chiplets 1020-1040. As the encrypted data signal travels between the chiplets 1020-1040, the encrypted data signal may be decrypted and re-encrypted or passed through the chiplets without being decrypted and re-encrypted. For example, the chiplet 1020 receives the encrypted data signal from the chiplet 1010. The chiplet 1020 may decrypt and re-encrypt the data signal before outputting the data signal to the chiplet 1030. In another example, the chiplet 1020 passes the encrypted data signal to the chiplet 1030 without decrypting the data signal.

At the chiplet 1080, the encrypted data signal is received and decrypted. The chiplet 1080 performs one or more operations on the decrypted data signal.

In an example, where the encrypted data signals are decrypted in the last (e.g. output) chiplet (e.g., the chiplet 1080), the chiplet 1080 stores multiple keys. In one example, the chiplet 1080 is configured similar to the chiplet 160 of FIG. 1. The chiplet 1080 stores a key for each associated chiplet 1010-1070 for which the chiplet 1080 will decrypt a corresponding encrypted data signal. In one example, other ones of the chiplets 1010-1070 may be used to decrypt an encrypted data signal from another chiplet. In such an example, the interconnection circuitry (e.g., the interconnection circuitry 134 of FIG. 1) of corresponding chiplet determines which chiplet to output the encrypted data signal to for decryption.

In one or more examples, one or more the chiplets 1010-1080 is able to decrypt received encrypted data signals for local traffic (e.g., traffic within the corresponding chiplet).

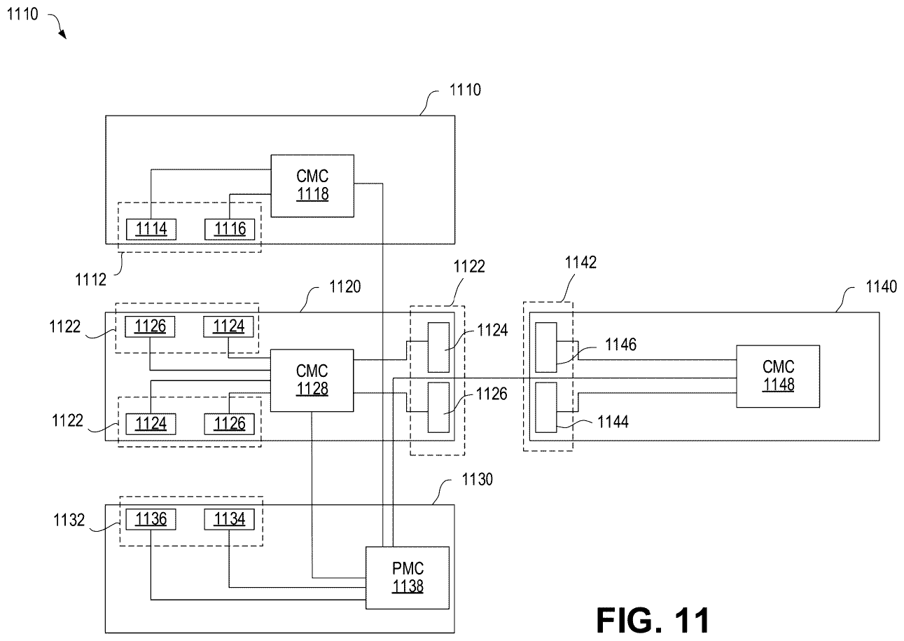

FIG. 11 illustrates the multi-chip IC device 1100. The multi-chip IC device 1100 includes chiplets 1110-1140. The chiplets 1110-1140 are configured similar to one or more of the chiplets 111-160 of FIG. 1.

The chiplet 1110 includes cryptography circuitry 1112 and CMC circuitry 1118. The cryptography circuitry 1112 includes encryption circuitry 1114 and decryption circuitry 1116. The chiplet 1120 includes cryptography circuitries 1122 and CMC circuitry 1128. Each of the cryptography circuitries 1122 includes encryption circuitry 1124 and decryption circuitry 1126. The chiplet 1130 includes cryptography circuitry 1132 and PMC circuitry 1138. The cryptography circuitry 1132 includes encryption circuitry 1134 and decryption circuitry 1136. The chiplet 1140 includes cryptography circuitry 1142 and CMC circuitry 1148. The cryptography circuitry 1142 includes encryption circuitry 1144 and decryption circuitry 1146.

In one example, the PMC circuitry 1138 controls updating the encryption key for the chiplets 1110, 1120, and 1140. For example, the PMC circuitry 1138 outputs one or more encryption keys to each of the CMC circuitries 1118, 1128, and 1148. In one or more examples, the PMC circuitry 1138 outputs a first encryption key to the CMC circuitry 1118. The CMC circuitry 1118 receives the first encryption key and outputs the first encryption key to the encryption circuitry 1114. The encryption circuitry 1114 outputs the first encryption key to the decryption circuitry 1126.

In one or more examples, the PMC circuitry 1138 outputs three encryption keys to the CMC circuitry 1128. The encryption keys are different from each other. A respective one of the encryption keys is output from the CMC circuitry 1128 to the encryption circuitries 1124. Each of the encryption circuitries 1124 outputs the corresponding encryption key to a respective one of the decryption circuitries 1116, 1136, and 1146.

The PMC circuitry 1138 outputs an encryption key to the CMC circuitry 1148. The CMC circuitry 1148 receives the encryption key and outputs the encryption key to the encryption circuitry 114. The encryption circuitry 1144 outputs the encryption key to the corresponding decryption circuitry 1126.

The PMC circuitry 1138 outputs an encryption key to the encryption circuitry 1134. The encryption circuitry 1134 outputs the encryption key to the corresponding decryption circuitry 1126. Accordingly, each of the pairs of encryption circuitries and decryption circuitries is updated with a respective encryption key.

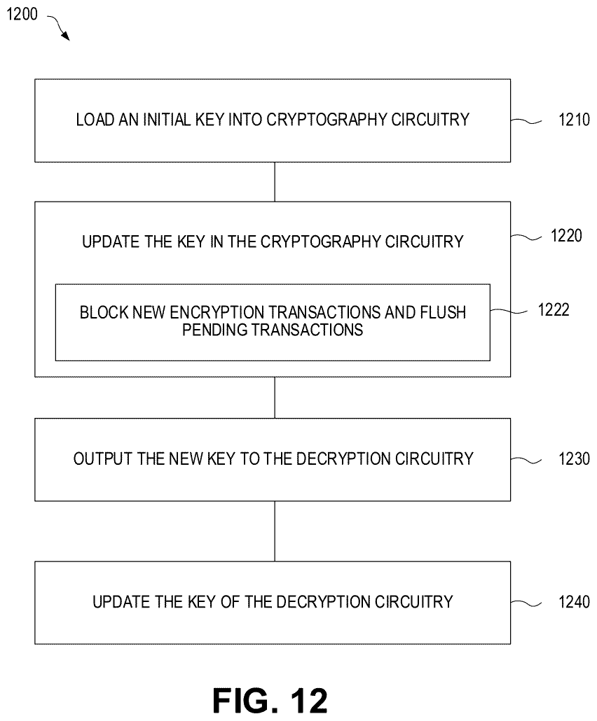

FIG. 12 illustrates a flowchart of the method 1200, according to one or more examples. The method 1200 is performed by one or more chiplets (e.g., the chiplets 110-160 of FIG. 1) of a multi-chip IC device (e.g., the multi-chip IC device 100 of FIG. 1). The method 1200 updates the encryption and decryption keys used in the encryption and decryption process.

At operation 1210, an initial key is loaded into the cryptography circuitry. For example, an initial key is loaded into the cryptography circuitry 324 of FIG. 2 of the interconnection circuitry 320. In one example, logic circuitry (e.g., the logic circuitry 136 of FIG. 1) of a chiplet loads the initial key into the cryptography circuitry. A secure communication channel within the interconnection circuitry may be used to load the initial key into the cryptography circuitry. In one or more examples, control circuitry within the interconnection circuitry receives the initial key from the logic circuitries and communicates the key to the corresponding cryptography circuitries within the interconnection circuitry. In one example, loading the initial key within the cryptography circuitry include loading the initial key within the encryption circuitry and/or decryption circuitry (e.g., the encryption circuitry 422 of FIG. 4 and/or decryption circuitry 722) of the cryptography circuitry. A register value indicating that the initial key has been loaded into the cryptography circuitries is set.

At operation 1220, the key within the cryptography circuitry is updated. For example, a new key is loaded into the cryptography circuitry 324 of FIG. 2 of the interconnection circuitry 320. In one example, logic circuitry (e.g., the logic circuitry 136 of FIG. 1) of a chiplet loads the new (updated) key into the cryptography circuitry. A secure communication channel within the interconnection circuitry may be used to load the updated key into the cryptography circuitry. In one or more examples, control circuitry within the interconnection circuitry receives the new key from the logic circuitries and communicates the updated key to the corresponding cryptography circuitries within the interconnection circuitry. In one example, loading the new key within the cryptography circuitry include loading the new key within the encryption circuitry and/or decryption circuitry (e.g., the encryption circuitry 422 of FIG. 4 and/or decryption circuitry 722) of the cryptography circuitry. A register value indicating that the new key has been loaded into the cryptography circuitries is set.

In one example, loading the new key in the cryptography circuitry includes operation 1222 of the method 1200, blocking new encryption transactions and flushing pending transactions. In one example, based on receiving the new key, the encryption circuitry (e.g., the encryption circuitry 42 of FIG. 4) blocks encrypting new transactions and completes and outputs all current transactions to be encrypted, encrypting the current transactions with the initial (or current) key.

At operation 1230 of the method 1200, the new key is output to the decryption circuitry. For example, the encryption circuitry block (e.g., the encryption circuitry block 410 of FIG. 4), encrypts the new key using the initial (or previous key) and outputs the encrypted key to the corresponding decryption circuitry block (e.g., the decryption circuitry block 710 of FIG. 7). The encrypted key is communicated with a destination identifier that indicates the target (e.g., destination) decryption circuitry block. In one example, the new key is encrypted and communicated based on a determination that the pending transactions have been flushed (e.g., completed) within the encryption circuitry.

At operation 1240 of the method 1200, the key decryption circuitry is updated. In one example, the decryption circuitry block receives the encrypted key including the destination identifier, and determines if the destination identifier of the encrypted key corresponds to that of the decryption circuitry block. Based on the destination identifier matching (e.g., corresponding to) the destination identifier of the decryption circuitry block, the decryption circuitry block decodes the encrypted key using the previous key and updates the key of the decryption circuitry block with the new key. Further, the decryption circuitry block flushes (e.g., completes) all pending transactions (e.g., encrypted signals) by decrypting the pending transactions with the previous key. The transactions received after the encrypted key is received are decrypted using the new key.

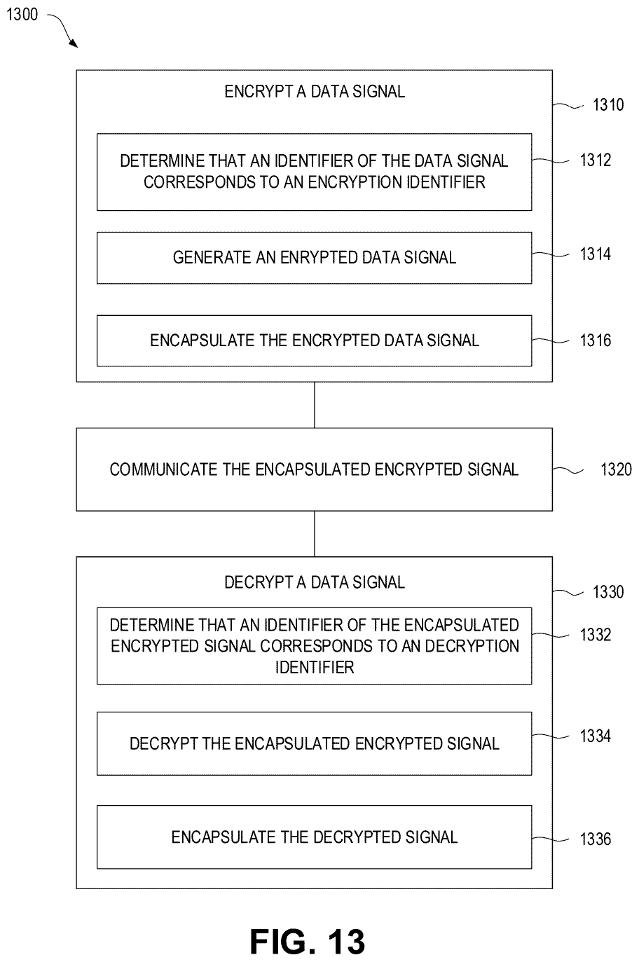

FIG. 13 illustrates a flowchart of a method 1300 for communicating an encrypted data signal in a multi-chip IC device. For example, the method 1300 may be used to communicate an encrypted data signal between chiplets (e.g., the chiplets 113-160 of FIG. 1) of a multi-chip IC device (e.g., the multi-chip IC device 100 of FIG. 1).

At operation 1310, a data signal is encrypted. In one example, the data signal is encrypted by cryptography circuitry (e.g., the cryptography circuitry 324 of FIG. 2) of interconnection circuitry (e.g., the interconnection circuitry 320 of FIG. 2). The data signal may be a read transaction or a write transaction. The data signal may consist of a plurality of beats (or bursts) that include data of the data signal. The data signal is encrypted using a key.

In one example, encrypting a data signal includes operation 1312, determining that the identifier of the data signal corresponds to an encryption identifier. As is described above with regard to FIG. 4, the ID check circuitry 420 determines if an identifier of a data signal corresponds to (e.g., matches) an encryption identifier.

In one example, encrypting a data signal includes operation 1314, encrypting the data signal. As is described above with regard to FIG. 4, the data signal is encrypted by the encryption circuitry 422 of FIG. 4 based on the determination that the identifier of the data signal corresponds the encryption identifier. In one or more examples, a hash function is applied to the data signal to authenticate the data signal before the data signal is encrypted at operation 1314. The hash function is performed by the encryption circuitry 422 of FIG. 4. In one example, the data of a signal is authenticated after the signal is determined to match an encryption ID and is a signal that is to be encrypted.

In one example, encrypting a data signal includes operation 1316, encapsulating the data signal. As is described above with regard to FIG. 4, the data signal is encapsulated by the encapsulation circuitry 424 of FIG. 4 based on the whether or not the data signal is a read transaction or a write transaction.

At operation 1320, the encapsulated encrypted signal is communicated. For example, the interconnection circuitry of a first chiplet (e.g., the chiplet 130 of FIG. 1) communicates the encapsulated encrypted signal to a second chiplet (e.g., the chiplet 150 of FIG. 1).

At operation 1330, an encapsulated encrypted signal is decrypted. In one example, the encapsulated encrypted signal is received and decrypted by cryptography circuitry (e.g., the cryptography circuitry 324 of FIG. 2) of interconnection circuitry (e.g., the interconnection circuitry 320 of FIG. 2). The encapsulated encrypted signal may be a read transaction or a write transaction. The encapsulated encrypted signal is decrypted using a key.

In one example, decrypting an encapsulated encrypted signal includes operation 1332, determining that the identifier of the encapsulated encrypted signal corresponds to a decryption identifier. As is described above with regard to FIG. 7, the ID check circuitry 720 determines if an identifier of an encapsulated encrypted signal corresponds to (e.g., matches) a decryption identifier.

In one example, decrypting an encapsulated encrypted signal includes operation 1334, decrypting the data signal. As is described above with regard to FIG. 7, the encapsulated encrypted signal is decrypted by the decryption circuitry 722 based on the determination that the identifier of the encapsulated encrypted signal corresponds the decryption identifier.

In one example, decrypting the encapsulated encrypted signal includes operation 1336, encapsulating the decrypted signal. As is described above with regard to FIG. 7, the decrypted signal is encapsulated by the encapsulation circuitry 724 based on the whether or not the data signal is a read transaction or a write transaction. The encapsulated decrypted signal is output from the corresponding interconnection circuitry.

In the multi-chip IC device described in the above, encryption and decryption circuitry is added to the interconnect circuitry to secure the data communicated between the chiplets. Using the above described methods, the communicated data can be selectively encrypted and decrypted. Further, critical data can be secured and non-critical data can be communicated without hindering the performance of the corresponding multi-chip IC device. Including the encryption an decryption circuitry within the interconnect circuitry as is described above uses less circuit area and less power as compared to devices that secure all of the data communicated between the chiplets.

While the foregoing is directed to specific examples, other and further examples may be devised without departing from the basic scope thereof, and the scope thereof is determined by the claims that follow.

What is claimed is:

1. A multi-chip integrated circuit (IC) device comprising:
a first chiplet comprising first interconnect circuitry, wherein the first interconnect circuitry is configured to encrypt a first signal and output the encrypted signal; and
a second chiplet comprising second interconnect circuitry, wherein the second interconnect circuitry is configured to:
receive the encrypted signal from the first chiplet and decrypt the encrypted signal to generate a decrypted signal; and
output the decrypted signal to the second chiplet for processing.

2. The multi-chip IC device of claim 1, wherein the first interconnect circuitry comprises first cryptography circuitry configured to encrypt the first signal, and wherein the second interconnect circuitry comprises second cryptography circuitry configured to decrypt the encrypted signal.

3. The multi-chip IC device of claim 2, wherein the first cryptography circuitry comprises:
identifier check circuitry configured to receive the first signal and to determine that the first signal is to be encrypted based on an identifier of the first signal;
encryption circuitry connected to the output of the identifier check circuitry and configured to receive the first signal from the identifier check circuitry based on the determination that the first signal is to be encrypted, and encrypt the first signal; and
encapsulation circuitry connected to the output of the encryption circuitry and configured to generate an encapsulated signal including the encrypted signal.

4. The multi-chip IC device of claim 3, wherein the first cryptography circuitry further comprises selection circuitry configured to select one of the encapsulated signal and a second signal to be output from the first interconnect circuitry, wherein the second signal is not encrypted.

5. The multi-chip IC device of claim 3, wherein the encapsulation circuitry is configured to accumulate beats of the encrypted signal and add header information to the accumulated beats to generate the encapsulated signal.

6. The multi-chip IC device of claim 2, wherein the second cryptography circuitry comprises:
identifier check circuitry configured to receive the encrypted signal and to determine that the encrypted signal is to be decrypted based on an identifier of the encrypted signal;
decryption circuitry connected to the output of the identifier check circuitry and configured to receive the encrypted signal from the identifier check circuitry based on the determination that the encrypted signal is to be decrypted, and decrypt the encrypted signal; and
encapsulation circuitry connected to the output of the decryption circuitry and configured to generate an encapsulated signal including the decrypted signal.

7. The multi-chip IC device of claim 5, wherein the first cryptography circuitry further comprises selection circuitry configured to select one of the encapsulated signal and a second signal to be output from the second interconnect circuitry, wherein the second signal is not encrypted.

8. The multi-chip IC device of claim 2, wherein encryption circuitry of the first cryptography circuitry receives an encryption key and outputs the encryption key to decryption circuitry of the second cryptography circuitry.

9. The multi-chip IC device of claim 8, wherein the encryption circuitry is configured to encrypt a second encryption key with the encryption key and output the encrypted second encryption key to the decryption circuitry, and the decryption circuitry is configured to decrypt the encrypted second encryption key with the encryption key.

10. The multi-chip IC device of claim 1 further comprising a third chiplet connected to the first chiplet and the second chiplet, and wherein the encrypted signal is communicated from the first chiplet to the third chiplet and form the third chiplet to the second chiplet.

11. The multi-chip IC device of claim 10, wherein the third chiplet does not perform an encryption process or decryption process on the encrypted signal.

12. The multi-chip IC device of claim 1, wherein the first signal is authenticated with a hash function before the first signal is encrypted.

13. An integrated circuit (IC) device comprising:
first interconnect circuitry configured to receive a first signal, encrypt the first signal and output the encrypted signal, wherein the first interconnect circuitry is configured to be connected to second interconnect circuitry of a second chiplet, wherein the first interconnect circuitry is configured to receive a second encrypted signal from the second chiplet and decrypt the second encrypted signal to generate a decrypted signal, and output the decrypted signal for processing.

14. The IC device of claim 13, wherein the first interconnect circuitry comprises first cryptography circuitry configured to encrypt the first signal and decrypt the second encrypted signal, and wherein the first cryptography circuitry comprises:
first identifier check circuitry configured to receive the first signal and to determine that the first signal is to be encrypted based on an identifier of the first signal;
first encryption circuitry connected to the output of the first identifier check circuitry and configured to receive the first signal from the first identifier check circuitry based on the determination that the first signal is to be encrypted, and encrypt the first signal;
first encapsulation circuitry connected to the output of the first encryption circuitry and configured to generate a first encapsulated signal including the encrypted signal; and
first selection circuitry configured to select one of the first encapsulated signal and a second signal to be output from the first interconnect circuitry, wherein the second signal is not encrypted.

15. The IC device of claim 14, wherein the first encapsulation circuitry is configured to accumulate beats of the encrypted signal and add header information to the accumulated beats to generate the first encapsulated signal.

16. The IC device of claim 14, wherein the first cryptography circuitry comprises:
second identifier check circuitry configured to receive the encrypted signal and to determine that the encrypted signal is to be decrypted based on an identifier of the encrypted signal;
second decryption circuitry connected to the output of the second identifier check circuitry and configured to receive the encrypted signal from the second identifier check circuitry based on the determination that the encrypted signal is to be decrypted, and decrypt the encrypted signal;
second encapsulation circuitry connected to the output of the second decryption circuitry and configured to generate a second encapsulated signal including the decrypted signal; and
second selection circuitry configured to select one of the second encapsulated signal and a second signal to be output from the first interconnect circuitry, wherein the second signal is not encrypted.

17. The IC device of claim 14, wherein encryption circuitry of the first cryptography circuitry receives an encryption key and outputs the encryption key to the second chiplet.

18. A method comprising:
encrypting, via first interconnect circuitry of a first chiplet of a multi-chip integrated circuit (IC) device, a first signal and output the encrypted signal;
receiving, via second interconnect circuitry of a second chiplet of the multi-chip IC device, the encrypted signal from the first chiplet;
decrypting, via the second interconnect circuitry, the encrypted signal to generate a decrypted signal; and
outputting the decrypted signal to the second chiplet for processing.

19. The method of claim 18 further comprising:
determining, via identifier check circuitry of first cryptography circuitry of the first interconnect circuitry, that the first signal is to be encrypted based on an identifier of the first signal;
encrypting, via encryption circuitry of the first cryptography circuitry, the first signal based on the determination that the first signal is to be encrypted;
generating, via encapsulation circuitry of the first cryptography circuitry, generate an encapsulated signal from the encrypted signal;
selecting one of the encapsulated signal and a second signal to be output from the first interconnect circuitry, wherein the second signal is not encrypted; and
accumulating, via the encapsulation circuitry, beats of the encrypted signal and adding header information to the accumulated beats to generate the encapsulated signal.

20. The method of claim 18 further comprising:
receiving, via identifier check circuitry of second cryptography circuitry of the second interconnect circuitry, the encrypted signal and determining that the encrypted signal is to be decrypted based on an identifier of the encrypted signal;
decrypting, via decryption circuitry of the second cryptography circuitry, the encrypted signal based on the determination that the first signal is to be decrypted; and
generating, via encapsulation circuitry of the second cryptography circuitry, an encapsulated signal including the decrypted signal.
